(19) United States
(12) Patent Application Publication
(10) Pub. No.: US 2025/0201241 A1
(43) Pub. Date: Jun. 19, 2025

(54) Large Language Model Response Conciseness for Spoken Conversation

(71) Applicant: Google LLC, Mountain View, CA (US)

(72) Inventors: Ping Zhong, Mountain View, CA (US); Ian McGraw, Menlo Park, CA (US)

(73) Assignee: Google LLC, Mountain View, CA (US)

(21) Appl. No.: 18/953,029

(22) Filed: Nov. 19, 2024

Related U.S. Application Data
(60) Provisional application No. 63/611,386, filed on Dec. 18, 2023.

(51) Int. Cl. G10L 15/183; G06F 16/242; G10L 15/06; G10L 15/22; G10L 15/30

(52) U.S. Cl. CPC G10L 15/183; G06F 16/243; G10L 15/063; G10L 15/22; G10L 15/30

(57) ABSTRACT

A method includes receiving a natural language query from a user that solicits a response from an assistant large language model (LLM), receiving a prompt composition including an instruction parameter that specifies a task for the assistant LLM to respond to user queries concisely, structuring a conciseness prompt by concatenating the prompt composition to the natural language query, and processing, using the assistant LLM, the conciseness prompt to generate a concise response to the natural language query. The method also includes providing, for output from a user device, the concise response to the natural language query.

### CROSS-REFERENCE TO RELATED APPLICATIONS

This U.S. Patent application claims priority under 35 U.S.C. § 119 (e) to U.S. Provisional Application 63/611,386, filed on Dec. 18, 2023. The disclosure of this prior application is considered part of the disclosure of this application and is hereby incorporated by reference in its entirety.

### TECHNICAL FIELD

This disclosure relates to large language model (LLM) response conciseness for spoken conversation.

### BACKGROUND

Large language models (LLMs) are increasingly used to provide conversational experiences between users and digital assistant interfaces executing on user devices. Generally, when a user provides a request/query to a digital assistant interface powered by an LLM, the resulting response generated by the LLM is relatively long for a typical turn in a conversation. Long responses may not be an issue for a dialog in text as the user can scan response text and filter out unimportant information quickly. However, in spoken conversations where the user speaks an input query/request and synthesized speech conveying the response generated by the LLM is audibly output, the user experience is hurt since the synthesized speech conveying the response to the query is typically too long for the user to hear and comprehend.

### SUMMARY

One aspect of the disclosure provides a computer-implemented method that when executed on data processing hardware causes the data processing hardware to perform operations that include receiving a natural language query from a user that solicits a response from an assistant large language model (LLM), receiving a prompt composition including an instruction parameter that specifies a task for the assistant LLM to respond to user queries concisely, structuring a conciseness prompt by concatenating the prompt composition to the natural language query, and processing, using the assistant LLM, the conciseness prompt to generate a concise response to the natural language query. The operations also include providing, for output from a user device, the concise response to the natural language query.

Implementations of the disclosure may include one or more of the following optional features. In some implementations, receiving the natural language query includes: receiving audio data characterizing an utterance of the natural language query spoken by the user and captured by the user device; and performing speech recognition on the audio data to generate a textual representation of the natural language query spoken by the user, while structuring the conciseness prompt includes concatenating the prompt composition to the textual representation of the natural language query. Here, concatenating the prompt composition to the textual representation of the natural language query may include pre-fixing the prompt composition to the textual representation of the natural language query.

In some examples, the instruction parameter that specifies the task for the assistant LLM to respond to user queries concisely further specifies a number of sentences for the assistant LLM to generate when responding to the user queries concisely. Additionally or alternatively, the instruction parameter may specify another task for the assistant LLM to add a suffix to a concise response generated by the LLM that asks the user a follow-up question related to the concise response. In some additional examples, the prompt composition further includes a constraint parameter specifying one or more constraints for concise responses generated by the assistant LLM. Here, the one or more constraints indicate at least one of a maximum number of words or a number of sentences the concise responses should include.

In some implementations, the prompt composition further includes one or more few-shot learning examples each depicting an exemplary query-concise response pair. Each query-concise response pair provides in-context learning for enabling the assistant LLM to generalize for the task of responding to user queries concisely. In these implementations, at least one of the one or more few-shot learning examples may include an exemplary initial response and a chain-of-thought reasoning for why or not the exemplary initial response is concise. Moreover, the prompt composition may further include a format parameter that specifies how the assistant LLM should format concise responses.

In some examples, the operations further include enabling a threshold parameter for triggering calibration when an initial response generated by the assistant LLM is too long. Here, processing the conciseness prompt to generate the concise response to the natural language query may include: processing, using the assistant LLM, the conciseness prompt to generate an initial LLM response to the natural language query; determining that the initial LLM response generated by the assistant LLM satisfies the threshold parameter; in response to determining the initial LLM response generated by the assistant LLM satisfies the threshold parameter, providing, as feedback to the assistant LLM, a calibration phrase that indicates the initial LLM response is too long; and based on the calibration phrase provided as feedback to the assistant LLM, processing, using the assistant LLM, the conciseness prompt and the initial LLM response to cause the assistant LLM to shorten and/or summarize the initial LLM response into the concise response. Notably, the initial LLM response may hidden from the user and not saved as part of a conversation history between the user and the assistant LLM.

Another aspect of the present disclosure provides a system that includes data processing hardware and memory hardware storing instructions that when executed on the data processing hardware causes the data processing hardware to perform operations that include receiving a natural language query from a user that solicits a response from an assistant large language model (LLM), receiving a prompt composition including an instruction parameter that specifies a task for the assistant LLM to respond to user queries concisely, structuring a conciseness prompt by concatenating the prompt composition to the natural language query, and processing, using the assistant LLM, the conciseness prompt to generate a concise response to the natural language query. The operations also include providing, for output from a user device, the concise response to the natural language query.

This aspect of the disclosure may include one or more of the following optional features. In some implementations, receiving the natural language query includes: receiving audio data characterizing an utterance of the natural language query spoken by the user and captured by the user device; and performing speech recognition on the audio data to generate a textual representation of the natural language query spoken by the user, while structuring the conciseness prompt includes concatenating the prompt composition to the textual representation of the natural language query. Here, concatenating the prompt composition to the textual representation of the natural language query may include pre-fixing the prompt composition to the textual representation of the natural language query.

In some examples, the instruction parameter that specifies the task for the assistant LLM to respond to user queries concisely further specifies a number of sentences for the assistant LLM to generate when responding to the user queries concisely. Additionally or alternatively, the instruction parameter may specify another task for the assistant LLM to add a suffix to a concise response generated by the LLM that asks the user a follow-up question related to the concise response. In some additional examples, the prompt composition further includes a constraint parameter specifying one or more constraints for concise responses generated by the assistant LLM. Here, the one or more constraints indicate at least one of a maximum number of words or a number of sentences the concise responses should include.

In some implementations, the prompt composition further includes one or more few-shot learning examples each depicting an exemplary query-concise response pair. Each query-concise response pair provides in-context learning for enabling the assistant LLM to generalize for the task of responding to user queries concisely. In these implementations, at least one of the one or more few-shot learning examples may include an exemplary initial response and a chain-of-thought reasoning for why or not the exemplary initial response is concise. Moreover, the prompt composition may further include a format parameter that specifies how the assistant LLM should format concise responses.

In some examples, the operations further include enabling a threshold parameter for triggering calibration when an initial response generated by the assistant LLM is too long. Here, processing the conciseness prompt to generate the concise response to the natural language query may include: processing, using the assistant LLM, the conciseness prompt to generate an initial LLM response to the natural language query; determining that the initial LLM response generated by the assistant LLM satisfies the threshold parameter; in response to determining the initial LLM response generated by the assistant LLM satisfies the threshold parameter, providing, as feedback to the assistant LLM, a calibration phrase that indicates the initial LLM response is too long; and based on the calibration phrase provided as feedback to the assistant LLM, processing, using the assistant LLM, the conciseness prompt and the initial LLM response to cause the assistant LLM to shorten and/or summarize the initial LLM response into the concise response. Notably, the initial LLM response may hidden from the user and not saved as part of a conversation history between the user and the assistant LLM.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for guiding a large language model (LLM) to generate concise responses to user queries.

FIGS. 2A and 2B are example prompt compositions for causing an LLM to generate a concise response.

FIG. 3A is an example graphical user interface displaying a response generated by an LLM that is not concise.

FIG. 3B is an example graphical user interface displaying a concise response generated by an LLM.

FIG. 3C is an example graphical user interface displaying a concise response and a follow-up question generated by an LLM.

FIG. 4 is a flowchart of an example arrangement of operations for a method of guiding a LLM to generate concise responses to user queries.

FIG. 5 is a schematic view of an example computing device that may be used to implement the systems and methods described herein.

Like reference symbols in the various drawings indicate like elements.

### DETAILED DESCRIPTION

Humans may engage in human-to-computer dialogs with interactive software applications referred to as “chatbots,” “voice bots”, “automated assistants”, “interactive personal assistants,” “intelligent personal assistants,” “conversational agents,” etc. via a variety of computing devices. As one example, these chatbots may correspond to a machine learning model or a combination of different machine learning models, and may be utilized to perform various tasks on behalf of users.

Chatbots adopting Large language models (LLMs) are currently opening up a wide range of applications due to their powerful understanding and generation capabilities which can operate over text, image, and/or audio inputs. These models are also being extended with actuation capabilities via integration mechanisms with various service providers.

LLMs are increasingly used to provide conversational experiences between users and digital assistant interfaces executing on user devices. Generally, when a user provides a request/query to a digital assistant interface powered by an LLM, the resulting response generated by the LLM is too verbose for a typical turn in a conversation. Long responses may not be an issue for a dialog in text as the user can scan response text and filter out unimportant information quickly. However, in spoken conversations where the user speaks an input query/request and synthesized speech conveying the response generated by the LLM is audibly output, the user experience is hurt since the synthesized speech conveying the response to the query is typically too long for the user to hear and comprehend.

The verbosity of textual responses generated by the LLM may result from the expression being too wordy. For instance, the response may include several vague words that could be replaced with one specific word and other words that do not deliver useful information could be deleted. Not to mention, an LLM response that includes several sentences can be further shorted by combining two or more the sentences. Another explanation for why LLM responses are so verbose is that LLMs are trained on reading forms of text to teach the LLMs to learn how to answer a question in an all-encompassing manner, thereby resulting in the LLM responses to talk about too many aspects/details in a single answer. Clearly, all-encompassing answers are unnatural in spoken conversational settings. as people conversing in spoken conversation tend to continue the conversation by asking follow-up questions rather than talking for a long time without stopping.

Implementations herein are directed toward improving conversation conciseness during spoken conversations between a user and an assistant LLM. Specifically, implementations are directed toward structuring a conciseness prompt that concatenates a prompt composition to a natural language textual query derived from a natural language utterance spoken by the user to cause an assistant LLM to generate a concise response to the textual query. The prompt composition may include natural language instructions for the assistant LLM to perform the task of generating a concise response to a user's query, constraints for the concise response, one or more few-shot learning examples each depicting an exemplary query-concise response pair to provide in-context learning for enabling the assistant LLM to generalize for the task of generating concise responses, and a format specifying how the assistant LLM should format the concise response for output to the user. In some examples, the few-shot learning examples provide chain-of-thought (CoT) reasoning that provides natural language reasoning for why or why not an exemplary LLM response is concise.

In some implementations, the conversational assistant application additionally enables a threshold parameter for triggering calibration when the response output by the LLM is too long despite the prompt composition specifying the instructions for the task of generating a concise response. In these implementations, a response to a textual query generated by the LLM that is too long triggers a calibration turn where a calibration phrase is returned to the LLM as feedback to indicate that the response generated by the LLM is too long. Here, the calibration phrase may inform the LLM to shorten/summarize the long response based on a conversation history including the conciseness prompt that was concatenated to the textual query, the textual query, and the LLM response that is deemed too long. Accordingly, based on the calibration phrase returned as feedback during the calibration turn and the conversation history, the LLM may summarize the long response to the concise response. In these implementations, the prompt composition may enable the threshold parameter for triggering calibration without including any few-shot learning examples (zero shot learning) or in combination with the one or more few-shot learning examples. An initial response may be deemed too long if it violates conditions/constraints specified by the threshold parameter.

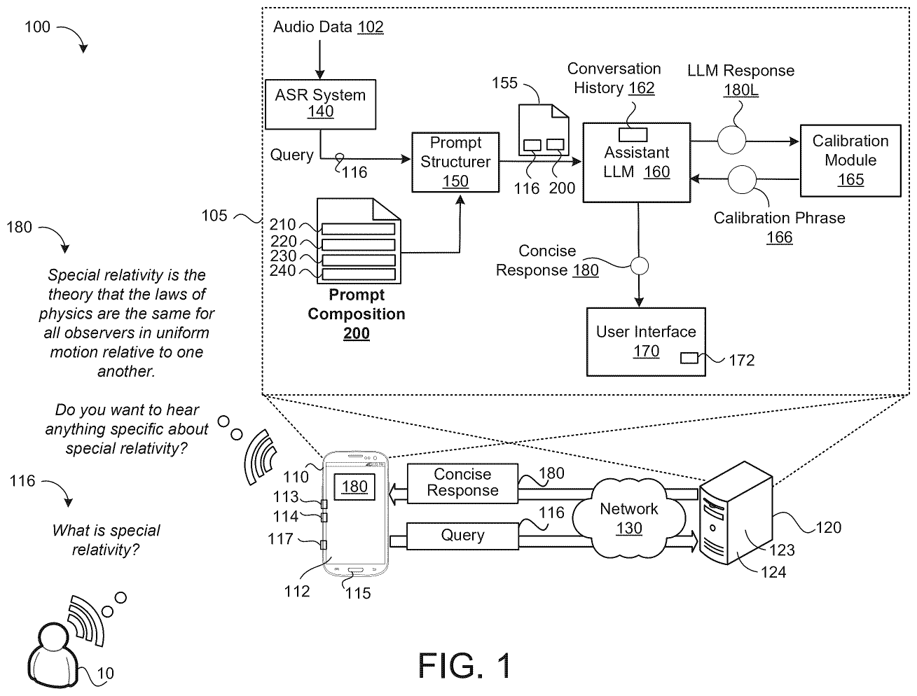

FIG. 1 illustrates an example system 100 for allowing a spoken conversation between a user 10 and an assistant LLM 160. A conversational assistant application 105 may execute on a user device 110 associated with the user 10 to enable the user 10 and the assistant LLM 160 to interact with one another through spoken conversation. The conversational assistant application 105 may access various components for facilitating the spoken conversation in a natural manner between the user 10 and the assistant LLM 160. For instance, through the use of application programming interfaces (APIs) or other types of plug-ins, the conversation assistant application 105 may access an automated speech recognition (ASR) system 140, a prompt structurer 150, the assistant LLM 160, a calibration module 165, and a user interface 170.

During a user turn of the spoken conversation between the user 10 and the assistant LLM 160, the user device 110 captures audio data 102 characterizing an utterance of a query 116 spoken by the user 10 and directed toward the assistant LLM 160 to solicit a response from the assistant LLM 160. For instance, the query 116 may specify a particular question that the user 10 would like the assistant LLM 160 to answer and the LLM 160 may generate a response that answers the question. The query 116 may similarly correspond to a request for information and the assistant LLM 160 may generate a response conveying the requested information. While the term query 116 is used, the query 116 may correspond to any natural language dialog (e.g., a greeting) directed toward the assistant LLM 160 during the user's turn in the spoken conversation between the user 10 and the assistant LLM 160. The user 10 may speak the utterance of the query 116 in natural language and the ASR system 140 may perform speech recognition on the audio data 102 characterizing the utterance of the query 116 to generate a textual representation of the query 116 spoken by the user 10. The textual representation of the query 116 may be simply referred to as a textual query 116. Thereafter, the prompt structurer 150 structurers a conciseness prompt 155 by concatenating a prompt composition 200 to the textual query 116, and then feeds the conciseness prompt 155 to the assistant LLM 160 to enable the assistant LLM 160 to perform the task of generating a response 180 to the user's query 116 such that the response 180 is concise and not too long. That is, the prompt composition 200 concatenated to the textual query 116 is configured to constrain or inhibit the assistant LLM 160 from generating a response to the query 116 that is too long and wordy for a typical natural spoken conversation. Stated differently, as the assistant LLM 160 is pre-trained on reading forms of text to teach the assistant LLM to learn how to answer a question in an all-encompassing manner, without the prompt composition 200, the assistant LLM 160 is inherently prone to generate responses that contain too many aspects/details in a single answer.

The system 100 includes the user device 110, a remote computing system 120, and a network 130. The user device 110 includes data processing hardware 113 and memory hardware 114. The user device 110 may include, or be in communication with, an audio capture device 115 (e.g., an array of one or more microphones) for converting utterances of natural language queries 116 spoken by the user 10 into corresponding audio data 102 (e.g., electrical signals or digital data). In lieu of spoken input, the user 10 may input a textual representation of the natural language query 116 via a user interface 150 executing on the user device 110. In scenarios when the user speaks a natural language query 116 captured by the microphone 115 of the user device 110, the ASR system 140 executing on the user device 110 or the remote computing system 120 may process the corresponding audio data 102 to generate a transcription of the query 116. Here, the transcription conveys the textual query 116 provided as input to the assistant interface 150. The ASR system 140 may implement any number and/or type(s) of past, current, or future speech recognition systems, models and/or methods including, but not limited to, an end-to-end speech recognition model, such as streaming speech recognition models having recurrent neural network-transducer (RNN-T) model architectures, a hidden Markov model, an acoustic model, a pronunciation model, a language model, and/or a naïve Bayes classifier.

The user device 110 may be any computing device capable of communicating with the remote computing system 120 through the network 130. The user device 110 includes, but is not limited to, desktop computing devices and mobile computing devices, such as laptops, tablets, smart phones, smart speakers/displays, digital assistant devices, smart appliances, internet-of-things (IoT) devices, infotainment systems, vehicle infotainment systems, and wearable computing devices (e.g., headsets, smart glasses, and/or watches).

The remote computing system 120 may be a distributed system (e.g., a cloud computing environment) having scalable elastic resources. The resources include computing resources 123 (e.g., data processing hardware) and/or storage resources 124 (e.g., memory hardware). Additionally or alternatively, the remote computing system 120 may be a centralized system. The network 130 may be wired, wireless, or a combination thereof, and may include private networks and/or public networks, such as the Internet.

With continued reference to FIG. 1, the components leveraged by the conversational assistant application 105 may execute on the data processing hardware 113 of the user device 110 or on the data processing hardware 123 of the remote computing system 120. In some implementations, the components leveraged by the conversational assistant application 105 executes on both the data processing hardware 113 of the user device 110 and the data processing hardware 123 of the remote computing system 120. For instance, one or more components of the conversational assistant application 105 may execute on the data processing hardware 113 of the user device 110 while one or more other components of the conversational assistant application 105 may execute on the remote computing system 120.

The assistant LLM 160 may power the conversational assistant application 105 to function as a personal chat bot capable of having dialog conversations with the user 10 in natural language and performing tasks/actions on the user's behalf. In some examples, the assistant LLM 160 includes an instance of Bard, LaMDA, BERT, Meena, ChatGPT, or any other previously trained LLM. These previously trained LLMs have been previously trained on enormous amounts of diverse data and are capable of engaging in corresponding conversations with users in a natural and intuitive manner. However, these LLMs have a plurality of machine learning (ML) layers and hundreds of millions to hundreds of billions of ML parameters.

By concatenating the prompt composition 200 to the textual query 116 to form the conciseness prompt 155, the conciseness prompt 155 guides the assistant LLM 160 to generate the conciseness response 180 to the query 116 as opposed to generating an all-encompassing response that contains too many aspects/details in a single answer. Notably, the conciseness prompt 155 guides the assistant LLM 160 to generate conciseness responses without training or updating parameters of the pre-trained LLM 160. The conversational assistant application 105 is configured to provide, for output from the user device 110, the concise response 180 generated by the assistant LLM 160. Here, the user interface 170 may audibly output, from an audio output device (e.g., acoustic speaker) 117, the concise response 180 as synthesized speech. For instance, the user interface 170 may include a text-to-speech (TTS) system 172 that converts a textual representation of the concise response 180 into synthesized speech conveying the concise response 180. Additionally or alternatively, the conversational assistant application 105 may instruct the user interface 170 to display, on a screen 112 in communication with the user device 110, text representing the concise response 180. In the example shown, the user speaks the natural query 116 of “What is special relatively?” and the assistant LLM 160 generates the concise response 180 of “Special relativity is the theory that the laws of physics are the same for all observers in uniform motion relative to on another”, which may be audibly output as synthesized speech and or displayed in text on the screen 112. In some examples, the assistant LLM 160 may add a suffix to the concise response 180 that asks the user 10 a follow-up question related to the concise response 180. For instance, in the example shown, the follow-up question added to the concise response 180 includes “Do you want to hear anything specific about special relativity?” Notably, the user interface 170 may display the conversational history of queries and conciseness responses during the spoken conversation between the user 10 and the assistant LLM 160.

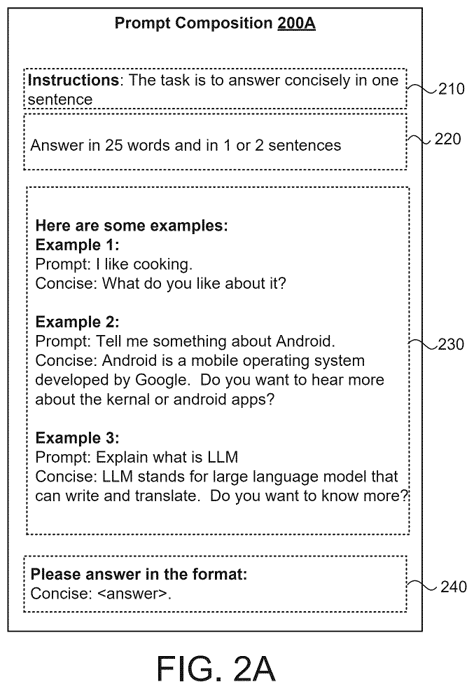

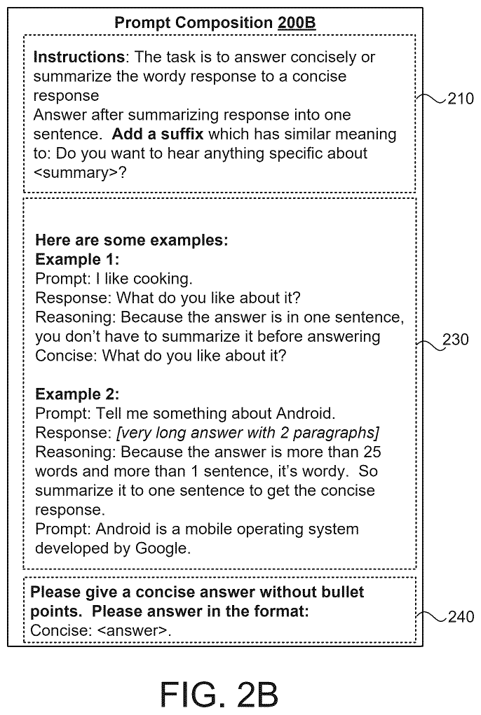

With continued reference to FIG. 1 and example prompt compositions 200A, 200B of FIGS. 2A and 2B, the prompt composition 200 includes an instruction parameter 210 that specifies a task for the assistant LLM 160 to response to user queries concisely. For instance, the prompt composition 200A of FIG. 2A includes the instruction parameter 210 having natural language text that states, “The task is to answer concisely in one sentence”. The prompt composition 200B of FIG. 2B includes the instruction parameter 210 having natural text that states, “the task is to answer concisely or summarize a wordy response to a concise response” and additionally specifies another task for the assistant LLM 160 to “Add a suffix which has similar meaning to: Do you want to hear anything specific about <summary>”. While not shown, the instruction for the task of adding the suffix may provide one or more examples of natural language follow-up questions that the LLM 160 may use as context for generating a follow-up to be added as the suffix to the concise response 180.

In some examples, the prompt composition 200 additionally includes a constraint parameter 220 that specifies one or more constraints for concise responses generated by the assistant LLM 160. For instance, the one or more constraints may indicate at least one of a maximum number of words or a number of sentences that the concise responses generated by the LLM 160 should include. For instance, the prompt composition 200A of FIG. 2A shows an example constrain parameter 220 specifying, in natural language, for the assistant LLM 160 to “Answer in 25 words and in 1 or 2 sentences”.

In some implementations, the prompt composition 200 also includes one or more few-shot learning examples 230 that each depict an exemplary query-concise response pair. Here, few-shot learning example 230 provides in-context learning for enabling the pre-trained assistant LLM 160 to generalize for the task of generating concise responses. The prompt composition 200A of FIG. 2A shows three few-shot learning examples 230 each including an example query/prompt paired with a corresponding concise response to the query/prompt. Optionally, one or more of the few-shot learning examples 230 may include concise responses having suffixes added thereto that provide an example of a natural language follow-up question for the user related to the conciseness response. For instance, the second few-shot learning example (Example 2) includes the concise response “Android is a mobile operating system developed by Google” with the follow-up suffix “Do you want to hear more about the kernal or Android apps?” In some scenarios, the prompt composition 200 includes one or more few-shot learning examples that additionally include an intermediate initial response to the query/prompt and chain-of-thought (CoT) reasoning that provides natural language reasoning for why or why not the initial response is concise. For instance, the prompt composition 200B of FIG. 2B includes a first few-shot learning example (Example 1) that pairs an initial response of “What do you like about it?” to the prompt “I like cooking” and provides CoT reasoning that states “Because the answer is in one sentence, you don't have to summarize it before answering”. Accordingly, the concise response of Example 1 corresponds to the initial response which was already concise by satisfying the conditions specified by the instruction parameter 210. By the same notion, the prompt composition 200B of FIG. 2B shows that the second few-shot learning example (Example 2) pairs a very long and wordy initial response to the query/prompt “Tell me something about Android” and provides CoT reasoning that states “Because the answer is more than 25 words and more than 1 sentence, it's wordy, So summarize it to one sentence to get the concise response”. The conciseness response 180 paired with the prompt/query of Example 2 concisely answers the prompt in a single sentence and in less than 25 words.

The prompt composition 200 may additionally include a format parameter 240 that specifies how the assistant LLM should format concise responses. For instance, the format parameter 240 included in the prompt composition 200A of FIG. 2A includes the natural language text “Please answer in the format: Concise: <answer>” while the format parameter 240 included in the prompt composition 200B of FIG. 2B includes the natural language text “Please give a concise answer without bullet points. Please answer in the format: Concise: <answer>”.

Referring to FIG. 1, in some implementations, the conversational assistant application 105 additionally enables a threshold parameter for trigger calibration when an initial response 180L generated by the LLM 160 is too long. Notably, the assistant LLM 160 may still generate a responses to a query that is too long for spoken conversations despite the query being concatenated with a prompt composition 200 that specifies the task for the assistant LLM 160 to generate a concise response. In these implementations, when the threshold parameter is enabled, the initial response 180L generated by the LLM 160 is input to a calibration module 165, and upon the calibration module 165 determining that the initial response 180L is too long, triggers a calibration turn by returning a calibration phrase 166 to the assistant LLM 160 as feedback that indicates that the initial response 180L is too long. The calibration phrase 166 may include the natural language phrase of “too long”. The calibration module 165 may receive the threshold parameter as one or more rules/constraints for conciseness. For instance, the threshold parameter may indicate a sentence count threshold and/or a word count threshold such that the initial response 180L triggers the calibration module 165 to return the calibration phrase 166 when the initial response 180L includes a number of sentences that exceeds the sentence count threshold and/or when the initial response 180L includes a number of words that exceeds the word count threshold. Based on the calibration phrase 166 provided as feedback to the assistant LLM 160 after the generating the initial response 180L, the assistant LLM 160 may process the conversation history including the conciseness prompt 155 input during the user's last turn and the resulting initial response 180L that was deemed too long to cause the assistant LLM 160 to shorten and/or summarize the initial response 180L into the concise response 180. Thereafter, the conversational assistant application 105 may provide the concise response 180 as an assistant turn in the conversation for output from the user device 110 as described above. Here, the initial LLM response that was deemed too long is hidden from the user and is not saved as part of the conversation history between the user and the assistant LLM. Notably, the threshold parameter may be enabled for trigger calibration without the prompt composition 200 pre-fixed to the user queries 116 including any few-shot learning examples (zero shot learning) or in combination with the prompt composition 200 including few-shot learning examples.

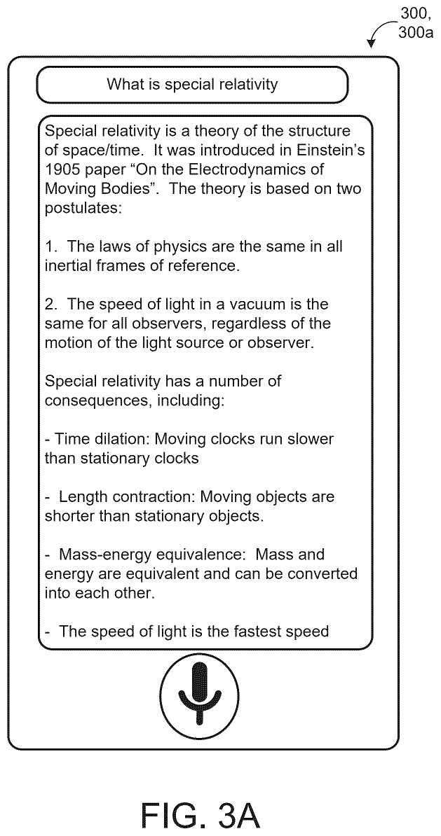

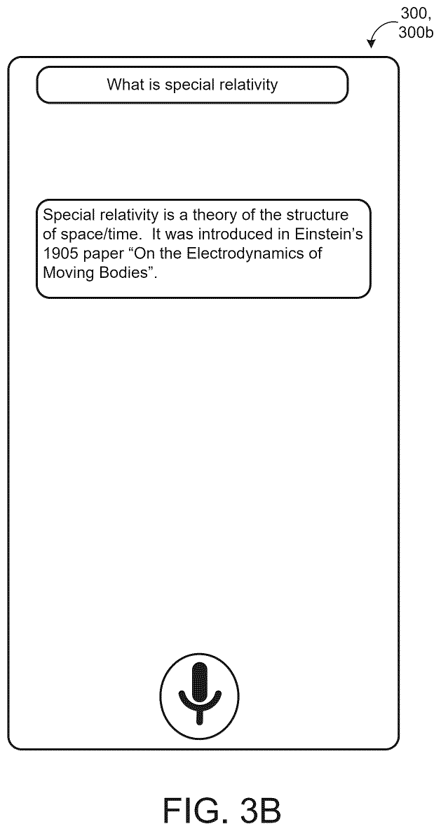

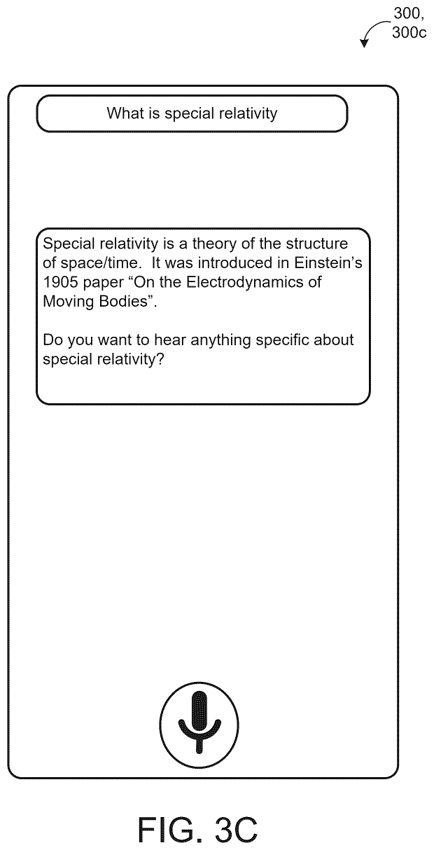

FIGS. 3A-3C illustrate example graphical user interfaces 300, 300a-c each depicting a response generated by the assistant LLM 160 to a same natural language query 116 spoken by the user 10 during a conversation between the user 10 and the assistant LLM 160. The user speaks the query 116 “What is special relativity?”. The GUIs 300 may display a transcription of the spoken query 116. The ASR system 140 may transcribe the spoken query 116 and provide the transcription/textual query 116 to the assistant LLM 160 for processing. The GUI 300a of FIG. 3A shows a response 300 generated by the LLM 160 without pre-fixing or otherwise concatenating a prompt composition 200 including instructions specifying a task for the assistant LLM 160 to generate concise responses to user queries. Notably, the response generated by the assistant LLM 160 and displayed in the GUI 300a is an all-encompassing response that includes multiple sentences and aspects in a single response. While the all-encompassing response does answer the query 116, the response is too long, and thus, unnatural in a spoken conversation setting.

FIG. 3B shows a concise response generated by the assistant LLM 160 and displayed in the GUI 300b. Here, the user's natural language query 116 is concatenated with the prompt composition 200A of FIG. 2A to cause the assistant LLM 160 to generate the concise response in one sentence and in less than 25 words as specified by the instruction parameter 210 and constraints parameter 220 of the prompt composition 200A. Notably, the concise response includes less words and less sentences than the verbose and all-encompassing response displayed in the GUI 300a of FIG. 3A. In some examples, the concise response displayed in the GUI 300b is generated responsive to a calibration phrase 166 provided as feedback to the LLM 160 when an initial response was deemed too long by the calibration module 165 of FIG. 1.

FIG. 3C also shows concise response with the addition of a suffix generated by the assistant LLM 160 and displayed in the GUI 300c. Here, the suffix generated by the assistant LLM 160 includes natural language text that asks the user a follow-up question related to the concise response. In the example shown, the follow-up question indicated by the suffix states “Do you want to hear anything specific about special relativity?” The assistant LLM 160 may generate the concise response with the suffix added thereto based on the instruction parameter 210 included in the prompt composition 200B of FIG. 2B.

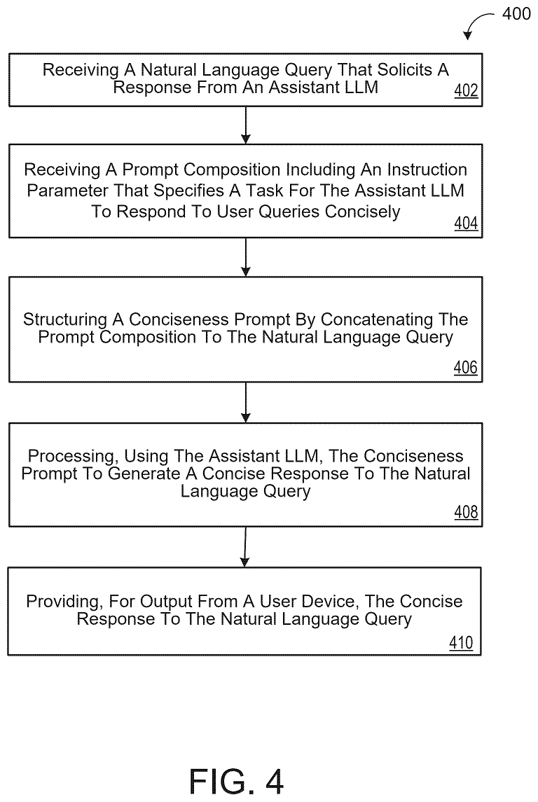

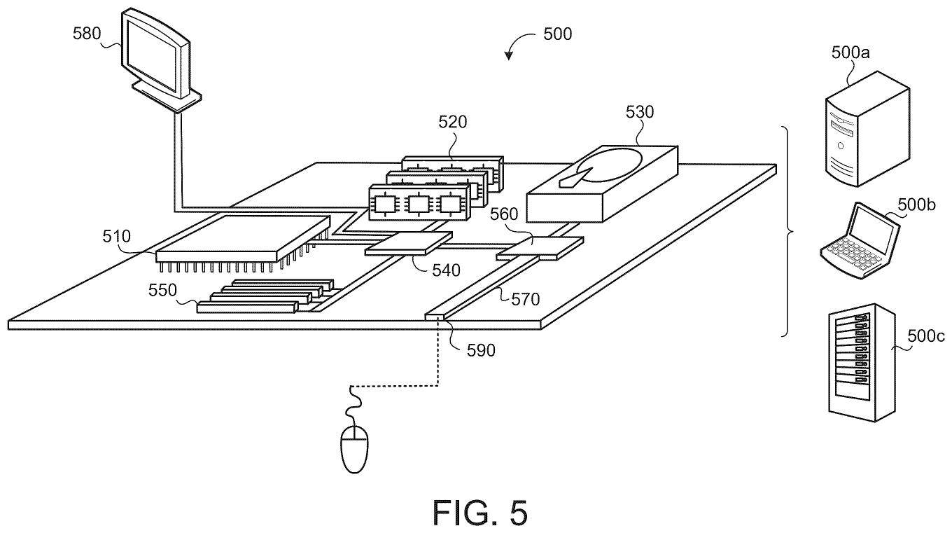

FIG. 4 is a flowchart of an example arrangement of operations for a method 400 of guiding a LLM to generate concise responses to user queries. The operations may execute on data processing hardware 510 (FIG. 5) based on instructions stored on memory hardware 520 (FIG. 5) in communication with the data processing hardware 510. The data processing hardware 510 may include the data processing hardware 113 of the user device 110 or the data processing hardware 123 of the remote computing system 120. The memory hardware 520 may include the memory hardware 114 of the user device 110 or the memory hardware 124 of the remote computing system 120.

At operation 402, the method 400 includes receiving a natural language query 116 from a user 10 that solicits a response from an assistant large language model (LLM) 160. At operation 404, the method 400 includes receiving a prompt composition 200 that includes an instruction parameter 210 that specifies a task for the assistant LLM 160 to respond to user queries concisely.

At operation 406, the method 400 includes structuring a conciseness prompt 155 by concatenating the prompt composition 200 to the natural language query 116. At operation 408, the method 400 includes processing, using the assistant LLM 160, the conciseness prompt 155 to generate a concise response 180 to the natural language query 116. At operation 410, the method 400 includes providing, for output from a user device 110, the concise response 180 to the natural language query 116.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

FIG. 5 is schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executing on data processing hardware that causes the data processing hardware to perform operations comprising:
receiving a natural language query from a user that solicits a response from an assistant large language model (LLM);
receiving a prompt composition comprising an instruction parameter that specifies a task for the assistant LLM to respond to user queries concisely;
structuring a conciseness prompt by concatenating the prompt composition to the natural language query;
processing, using the assistant LLM, the conciseness prompt to generate a concise response to the natural language query; and
providing, for output from a user device, the concise response to the natural language query.

2. The method of claim 1, wherein:
receiving the natural language query comprises:
receiving audio data characterizing an utterance of the natural language query spoken by the user and captured by the user device; and
performing speech recognition on the audio data to generate a textual representation of the natural language query spoken by the user; and
structuring the conciseness prompt comprises concatenating the prompt composition to the textual representation of the natural language query.

3. The method of claim 2, wherein concatenating the prompt composition to the textual representation of the natural language query comprises pre-fixing the prompt composition to the textual representation of the natural language query.

4. The method of claim 1, wherein the instruction parameter that specifies the task for the assistant LLM to respond to user queries concisely further specifies a number of sentences for the assistant LLM to generate when responding to the user queries concisely.

5. The method of claim 1, wherein the instruction parameter specifies another task for the assistant LLM to add a suffix to a concise response generated by the LLM that asks the user a follow-up question related to the concise response.

6. The method of claim 1, wherein the prompt composition further comprises a constraint parameter specifying one or more constraints for concise responses generated by the assistant LLM, the one or more constraints indicating at least one of a maximum number of words or a number of sentences the concise responses should include.

7. The method of claim 1, wherein the prompt composition further comprises one or more few-shot learning examples each depicting an exemplary query-concise response pair, each query-concise response pair providing in-context learning for enabling the assistant LLM to generalize for the task of responding to user queries concisely.

8. The method of claim 7, wherein at least one of the one or more few-shot learning examples comprises an exemplary initial response and a chain-of-thought reasoning for why or not the exemplary initial response is concise.

9. The method of claim 1, wherein the prompt composition further comprises a format parameter that specifies how the assistant LLM should format concise responses.

10. The method of claim 1, wherein the operations further comprises enabling a threshold parameter for triggering calibration when an initial response generated by the assistant LLM is too long.

11. The method of claim 10, wherein processing the conciseness prompt to generate the concise response to the natural language query comprises:
processing, using the assistant LLM, the conciseness prompt to generate an initial LLM response to the natural language query;
determining that the initial LLM response generated by the assistant LLM satisfies the threshold parameter;
in response to determining the initial LLM response generated by the assistant LLM satisfies the threshold parameter, providing, as feedback to the assistant LLM, a calibration phrase that indicates the initial LLM response is too long; and
based on the calibration phrase provided as feedback to the assistant LLM, processing, using the assistant LLM, the conciseness prompt and the initial LLM response to cause the assistant LLM to shorten and/or summarize the initial LLM response into the concise response.

12. The method of claim 11, wherein the initial LLM response is hidden from the user and not saved as part of a conversation history between the user and the assistant LLM.

13. A system comprising:
data processing hardware; and
memory hardware in communication with the data processing hardware, the memory hardware storing instructions that when executed on the data processing hardware cause the data processing hardware to perform operations comprising:
receiving a natural language query from a user that solicits a response from an assistant large language model (LLM);
receiving a prompt composition comprising an instruction parameter that specifies a task for the assistant LLM to respond to user queries concisely;
structuring a conciseness prompt by concatenating the prompt composition to the natural language query;
processing, using the assistant LLM, the conciseness prompt to generate a concise response to the natural language query; and
providing, for output from a user device, the concise response to the natural language query.

14. The system of claim 13, wherein:
receiving the natural language query comprises:
receiving audio data characterizing an utterance of the natural language query spoken by the user and captured by the user device; and
performing speech recognition on the audio data to generate a textual representation of the natural language query spoken by the user; and
structuring the conciseness prompt comprises concatenating the prompt composition to the textual representation of the natural language query.

15. The system of claim 14, wherein concatenating the prompt composition to the textual representation of the natural language query comprises pre-fixing the prompt composition to the textual representation of the natural language query.

16. The system of claim 13, wherein the instruction parameter that specifies the task for the assistant LLM to respond to user queries concisely further specifies a number of sentences for the assistant LLM to generate when responding to the user queries concisely.

17. The system of claim 13, wherein the instruction parameter specifies another task for the assistant LLM to add a suffix to a concise response generated by the LLM that asks the user a follow-up question related to the concise response.

18. The system of claim 13, wherein the prompt composition further comprises a constraint parameter specifying one or more constraints for concise responses generated by the assistant LLM, the one or more constraints indicating at least one of a maximum number of words or a number of sentences the concise responses should include.

19. The system of claim 13, wherein the prompt composition further comprises one or more few-shot learning examples each depicting an exemplary query-concise response pair, each query-concise response pair providing in-context learning for enabling the assistant LLM to generalize for the task of responding to user queries concisely.

20. The system of claim 19, wherein at least one of the one or more few-shot learning examples comprises an exemplary initial response and a chain-of-thought reasoning for why or not the exemplary initial response is concise.

21. The system of claim 13, wherein the prompt composition further comprises a format parameter that specifies how the assistant LLM should format concise responses.

22. The system of claim 13, wherein the operations further comprises enabling a threshold parameter for triggering calibration when an initial response generated by the assistant LLM is too long.

23. The system of claim 22, wherein processing the conciseness prompt to generate the concise response to the natural language query comprises:
processing, using the assistant LLM, the conciseness prompt to generate an initial LLM response to the natural language query;
determining that the initial LLM response generated by the assistant LLM satisfies the threshold parameter,
in response to determining the initial LLM response generated by the assistant LLM satisfies the threshold parameter, providing, as feedback to the assistant LLM, a calibration phrase that indicates the initial LLM response is too long; and
based on the calibration phrase provided as feedback to the assistant LLM, processing, using the assistant LLM, the conciseness prompt and the initial LLM response to cause the assistant LLM to shorten and/or summarize the initial LLM response into the concise response.

24. The system of claim 23, wherein the initial LLM response is hidden from the user and not saved as part of a conversation history between the user and the assistant LLM.
